(19) United States
(12) Patent Application Publication
(10) Pub. No.: US 2014/0083242 A1
(43) Pub. Date: Mar. 27, 2014

(54) Damping Apparatus for Flywheel

(71) Applicant: HYUNDAI MOTOR COMPANY, Seoul (KR)

(72) Inventor: Wan Soo OH, Yongin-si (KR)

(73) Assignee: Hyundai Motor Company, Seoul (KR)

(21) Appl. No.: 13/693,889

(22) Filed: Dec. 4, 2012

(30) Foreign Application Priority Data
Sep. 21, 2012 (KR) 10-2012-0105472

(51) Int. Cl. F16F 15/30

(52) U.S. Cl. CPC F16F 15/30
USPC 74/574.2

(57) ABSTRACT

A damping apparatus of a flywheel includes a pair of rotors and a weight. The rotors are provided in the flywheel and rotate along with the flywheel. The rotors receive torsional vibration from an engine through the flywheel, and are configured such that they face each other and are restricted from rotating relative to each other. The weight is provided between the rotors. The weight rotates relative to the rotors in a direction in which the torsional vibration transmitted to the rotors is offset.

### CROSS-REFERENCE TO RELATED APPLICATION

The present application claims priority of Korean Patent Application Number 10-2012-0105472 filed Sep. 21, 2012, the entire contents of which application is incorporated herein for all purposes by this reference.

### BACKGROUND OF INVENTION

1. Field of Invention

The present invention relates generally to damping apparatuses for flywheels and, more particularly, to a damping apparatus for a flywheel in which a weight is installed between two rotors, thus having an advantage of maintaining the rotational balance and the center of gravity of the weight, and which is configured such that the number of holes formed in the rotors is reduced, thus increasing the inertia of the rotors, and enhancing the durability of the rotors.

2. Description of Related Art

Generally, in internal combustion engines, variation in piston gas pressure inevitably causes an imbalance of drive force. As a result, a torsional exciting force is generated in an engine. Given this, it is preferable that transmission of power of the engine be maintained as smooth as possible while the engine rotates.

In terms of NVH of a drive system, a flywheel functions to use the moment of inertia and make the rpm of the engine constant, and to reduce frequency deviation of torsional vibration transmitted from the engine, thus reducing NVH problems (running and idle rattle and so on) of the drive system.

Recently, vehicles provided with high-performance engines (using GDI, turbochargers, superchargers, twin turbos, etc.) are being competitively developed and released. Particularly, to solve a problem of an unsatisfactory sense of launch (direct launch) in launching luxury vehicles, the use of engines which can generate high-torque at a low speed is being promoted.

However, in the case of such engines, as shown in FIG. 1, a torsional exciting force of the engine is further increased, thus worsening NVH problems such as rattle and booming. Further, shock and noise attributable to rattle resulting from an increase in the magnitude of torsional vibration are further increased in shift gear pairs of a transmission.

To overcome the above problems, a damping apparatus was proposed. As shown in FIG. 2, the conventional damping apparatus is configured such that a weight is rotatably installed in a dual mass flywheel.

In detail, as shown in FIGS. 2 and 3, a pair of weights 2 are provided at each of a plurality of positions on opposite sides of a rotational flange 1. Each weight 2 is provided on the rotational flange 1 so as to be rotatable relative to it. Fastening pins 3 are fitted into the rotational flange 1 such that opposite ends of the fastening pins 3 are exposed out of the rotational flange 1. The weights 2 are fastened to the respective opposite ends of each fastening pin 3. The weights 2 disposed at opposite positions rotate relative to the rotational flange 1 at the same time.

Furthermore, pendulum holes H are formed in at least one of the weights 2 and the rotational flange 1 and extend in the direction in which the rotational flange 1 rotates. A pendulum roller 4 which is coupled to the rotational flange 1 is disposed in each pendulum hole H. The weights 2 rotate relative to the rotational flange 1 within ranges defined by the corresponding pendulum holes, thus reducing torsional vibration transmitted from the engine.

However, in the conventional damping apparatus, the weights are provided on opposite sides of the rotational flange so that it is very difficult to correctly adjust the rotational balance and the center of gravity of the weights that are disposed at opposite positions. Given the fact that the position of the center of gravity of the weights is one of important factors of the damping performance of the damping apparatus, if the center of gravity of weights is not correctly controlled, the performance of the damping apparatus is reduced.

Moreover, separate holes H′ into which the fastening pins are inserted are formed in the rotational flange. These holes must extend longer lengths along the path of the movement of the weights. The formation of the holes causes problems of not only the weight of the rotational flange being reduced but also the durability of the rotational flange being weakened. Further, the formation of the holes makes it more difficult to adjust the rotational balance of the weights.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the prior art. Various aspects of the present invention provide for a damping apparatus of a flywheel in which a weight is installed between two rotors, thus having an advantage of keeping the rotational balance and the center of gravity of the weight, and which is configured such that the number of holes formed in the rotors is reduced, thus increasing the inertia of the rotors and enhancing the durability of the rotors

Various aspects of the present invention provide for a damping apparatus of a flywheel, including: a pair of rotors provided in the flywheel and rotating along with the flywheel, the rotors receiving torsional vibration from an engine through the flywheel and being configured such that the rotors face each other and are restricted from rotating relative to each other; and a weight provided between the rotors, the weight rotating relative to the rotors in a direction in which the torsional vibration transmitted to the rotors is offset.

Furthermore, a pendulum hole may be formed in each of the weight and the rotors, wherein the pendulum holes may extend in a direction in which the weight and the rotors rotate relative to each other. A pendulum roller may be disposed in the pendulum holes so as to be movable in the pendulum holes so that the weight is able to rotate relative to the rotors.

The flywheel may include a primary flywheel and a secondary flywheel that are connected to opposite ends of the rotors. A first end of the rotors may be fastened to either the primary flywheel or the secondary flywheel. A second end of the rotors may be rotatably coupled to a remaining one of the primary flywheel and the secondary flywheel by a damping spring.

A fastening member may be provided on the rotors in such a shape that the fastening member covers portions of edges of the rotors. The fastening member may be fastened to the rotors by a pin. A connection piece may extend outward from the fastening member. A first end of the damping spring may be connected to the connection piece.

The rotors may be fastened to each other by a pin. A connection piece may extend outwards from one of the rotors. A first end of the damping spring may be connected to the connection piece.

In the present invention, a weight may be interposed between two rotors rather than being disposed on opposite sides of the rotor. Therefore, the center of gravity and the inertia of the weight can be easily controlled so that the workability for installation of the weight can be enhanced. Further, the rotational balance of the weight is reliably maintained. As a result, the vibration reduction performance of the damping apparatus can be markedly enhanced.

Moreover, a pin which fastens the two rotors to each other can be installed such that it does not interfere with the weight. Hence, it is not necessary to form separate holes for installation of the pin in the rotors. The durability of the rotors 20 can thus be enhanced. In addition, a problem of the weight of the rotors being reduced if a hole is formed in the rotors can be solved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing variation in torsional exciting force depending on application of a high-powered engine.

FIG. 2 is a view showing the construction of a damping apparatus according to a conventional technique.

FIG. 3 is a view illustrating the shape of a rotor and the installation structure of a weight of the damping apparatus according to the conventional technique.

FIG. 4 is a view illustrating the construction of an exemplary damping apparatus according to the present invention.

FIG. 5 is a perspective view of the damping apparatus of FIG. 4.

FIG. 6 is a view showing an example of the installation of the weight of the damping apparatus of FIG. 4.

FIG. 7 is a view illustrating the construction of an exemplary damping apparatus according to the present invention.

FIG. 8 is a perspective view of the damping apparatus of FIG. 7.

FIG. 9 is of views illustrating a principle of reducing torsional vibration using the weight of a damping apparatus according to the present invention.

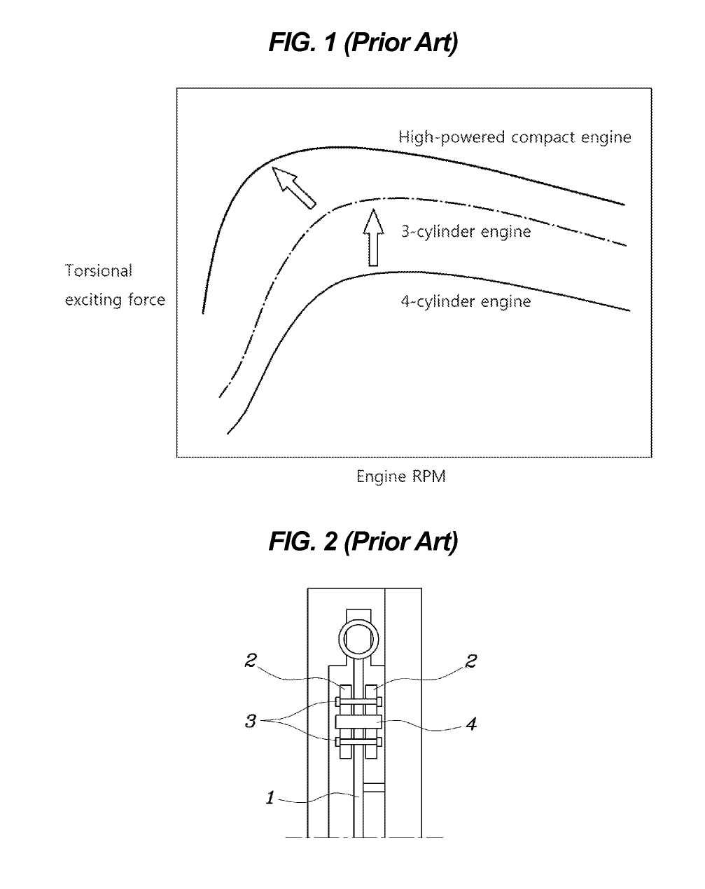

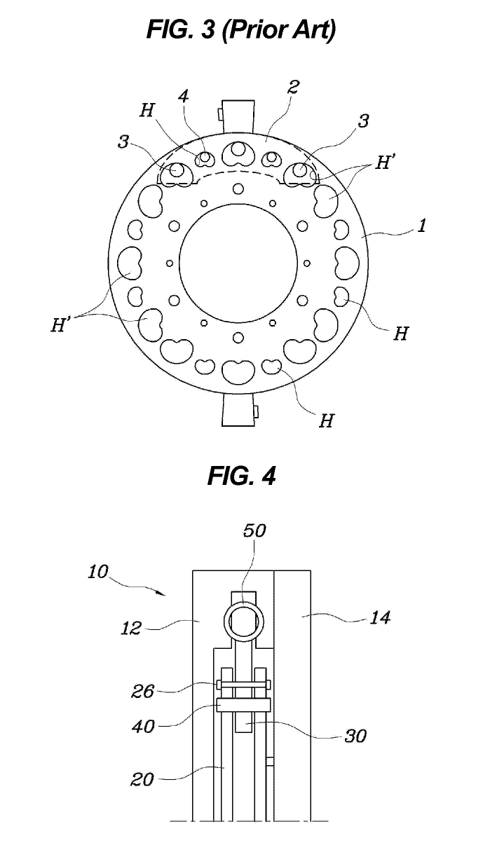

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

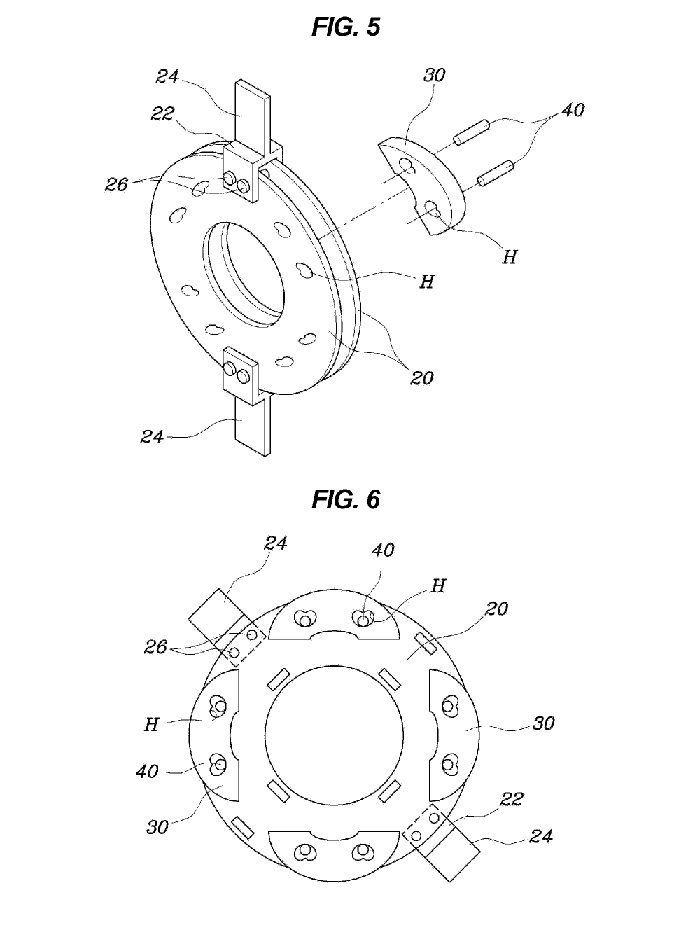

As shown in FIGS. 4 through 9, a damping apparatus for flywheels according to the present invention includes a pair of rotors 20 and weights 30. The rotors 20 are provided in a flywheel 10 and rotate along with it. The rotors 20 receive torsional vibration from an engine through the flywheel 10. The rotors 20 face each other and are restricted from rotating relative to each other. The weights 30 are provided between the rotors 20 and are configured such that they rotate relative to the rotors 20 in a direction in which torsional vibration transmitted to the rotors 20 is offset.

In detail, the weights 30 each of which has a predetermined weight are installed along the circumference of the rotors 20. Particularly, the weights 30 are disposed between the rotors 20. Thereby, the center of gravity and the inertia of each of the weights 30 installed between the rotors 20 can be easily controlled so that the installation of the weights 30 can be facilitated, and work of matching the centers of gravity of the weights disposed at opposite sides with each other can be skipped, unlike the conventional technique. As a result, the workability for installation of the weights 30 can be enhanced.

Moreover, because the weights 30 are installed between the two rotors 20, a separate fastening pin is not required to fasten the weights 30 to the rotors 20, unlike the conventional technique. Therefore, the number of elements is reduced. This can reduce the number of processes for manufacturing the damping apparatus and the production cost of the apparatus.

In the present invention, pendulum holes H are formed in the weights 30 and the rotors 20. The pendulum holes H extend in directions in which the weights 30 and the rotors 20 rotate relative to each other. Pendulum rollers 40 are disposed in the corresponding pendulum holes H so as to be movable in the pendulum holes H so that the weights 30 can rotate relative to the rotors 20.

The pendulum holes H may be formed both in the two rotors 20 and in the weights 30. Alternatively, the pendulum holes H may be selectively formed in either the two rotors 20 or the weights 30. In the case where the pendulum holes H are formed both in the two rotors 20 and the weights 30, each pendulum rotor 40 is movably disposed in the corresponding pendulum hole H formed in the weight 30, and opposite ends of the pendulum rotor 40 are movably disposed in the corresponding pendulum holes H formed in the two rotors 20.

In various embodiments, the shape of each pendulum hole H is that of an approximately heart. The heart shape of each of the pendulum holes H formed in the weights 30 is oriented in a direction in which it is turned upside down relative to the corresponding pendulum holes H formed in the two rotors 20.

In the present invention, the flywheel 10 includes a primary flywheel 12 and a secondary flywheel 14 which are provided on opposite sides of the rotors 20 and connected to each other. A first end of the rotors 20 is fastened to either the primary flywheel 12 or the secondary flywheel 14. A second end of the rotors 20 is rotatably coupled to the remaining one of the primary flywheel 12 and the secondary flywheel 14 by a damping spring 50.

For instance, a first end of the damping spring 50 is connected to the primary flywheel 12. A second end of the damping spring 50 is connected to the second end of the rotors 20, and the first end of the rotors 20 is fastened to the second flywheel 14.

That is, the damping apparatus of the present invention is used in the flywheel 10 which is directly connected to a crankshaft of the engine and rotates along with the crankshaft. The flywheel 10 may be provided with the damping apparatus is a dual mass flywheel 10. In this case, the primary flywheel 12 is directly connected to the engine, and the secondary flywheel 14 is coupled to a clutch housing. The connection or interruption operation of the clutch controls the transmission of rotational power from the engine to a transmission.

Therefore, the damping spring 50 can mitigate torsional vibration caused by the power of the engine that is transmitted by the primary flywheel 12 before the mitigated torsional vibration is transmitted to the transmission via the rotors 20 and the second flywheel 14.

Particularly, the weights 30 which are rotatably installed in the rotors 20 further mitigate torsional vibration transmitted from the engine to the rotors 20 so that the NVH performance of the drive system can be further enhanced.

Various embodiments of the structure of installing the rotors 20 and the weights 30 in the flywheel 10 according to the present invention will be described with reference to FIGS. 4 through 6. A fastening member 22 is provided on the two rotors 20 in such a shape that it covers portions of the edges of the two rotors 20. The fastening member 22 and the two rotors 20 are fixed to each other by a pin 26. A connection piece 24 extends outward from an outer surface of the fastening member 22. The first end of the damping spring 50 is connected to the connection piece 24.

In detail, the fastening member 22 has an approximate U shape. The opposite ends of the fastening member 22 are fitted over the edges of the two rotors 20. The pin 26 is inserted into the overlapped portions between the rotors 20 and the fastening member 22 so that the two rotors 20 are fixed to the fastening member 22 and thus prevented from rotating relative to each other. The connection piece 24 protrudes outward from the outer surface of the fastening member 22. The first end of the damping spring 50 is fixed to the connection piece 24 so that the rotors 20 can rotate relative to the primary flywheel 12 with the elasticity of the damping spring 50.

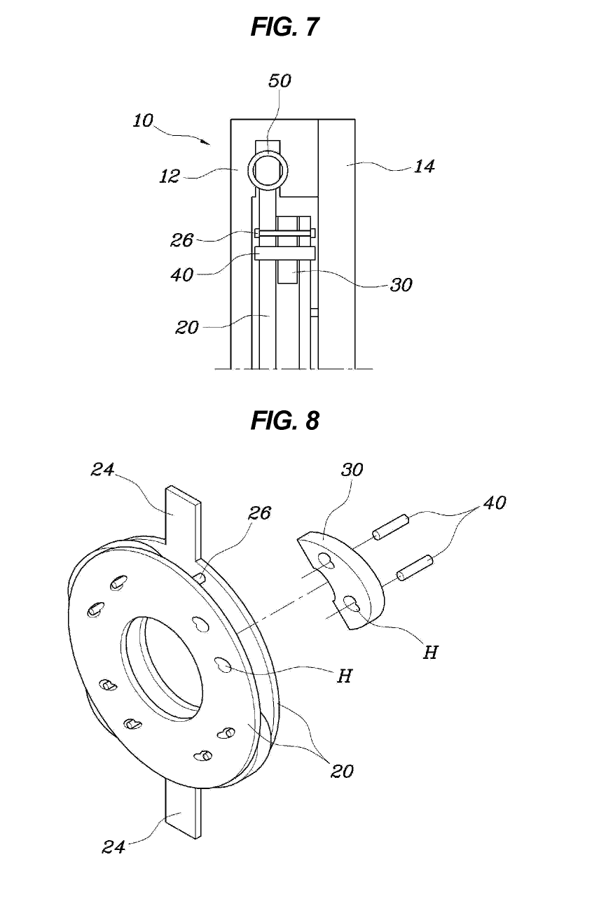

Various other embodiments of the structure of installing the rotors 20 and the weights 30 in the flywheel 10 will be described with reference to FIGS. 7 and 8. In various embodiments, a pin 26 is used to fasten the two rotors 20 to each other. A connection piece 24 extends outward from one of the two rotors 20. The first end of the damping spring 50 is connected to the connection piece 24.

In detail, the fastening pin 26 is installed between the two rotors 20 at a position at which it does not interfere with the weights 30. Thereby, the two rotors 20 are fixed to each other and thus prevented from rotating relative to each other. The connection piece 24 extends from the edge of the rotor 20 that is disposed adjacent to the primary flywheel 12. The first end of the damping spring 50 is fixed to the connection piece 24 so that the rotors 20 can rotate relative to the primary flywheel 12 with the elasticity of the damping spring 50.

The operation and effect of the present invention will be described in detail.

When rotational drive force having a predetermined wave is transmitted from the engine to the primary flywheel 12, torsional rotational vibration is transmitted to the primary flywheel 12. The torsional rotational vibration is transmitted to the rotors 20 by the damping spring 50 while the rotors 20 rotate relative to the primary flywheel 12. Thereby, the magnitude of torsional vibration applied to the rotors 20 can be reduced.

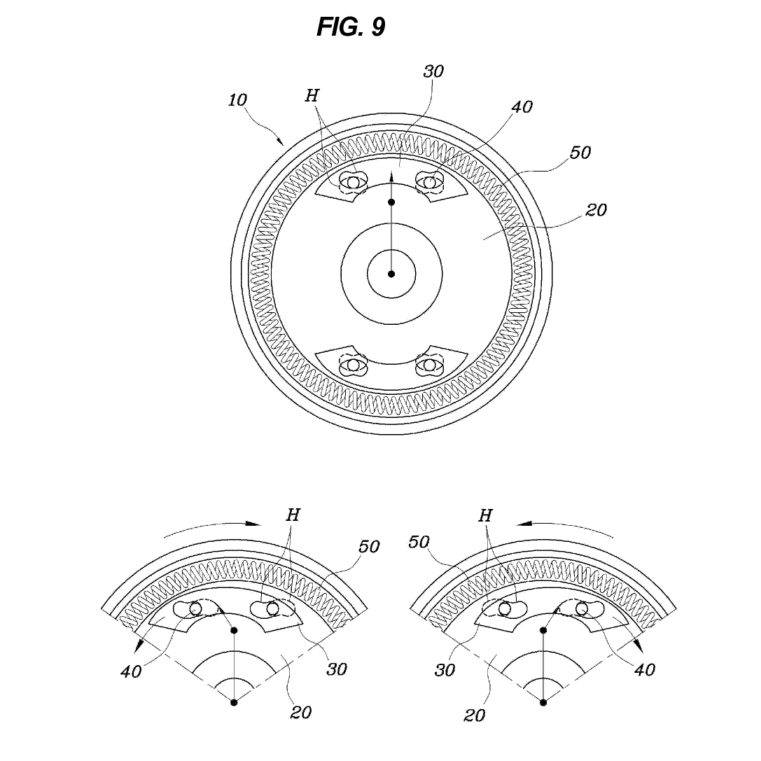

Furthermore, when torsional vibration is transmitted to the rotors 20, as shown in FIG. 9, the weights 30 move as they rotate relative to the rotors 20 in the direction opposite to the direction in which the rotors 20 are momentarily rotated by torsional vibration. While the weights 30 rotate relative to the rotors 20, the pendulum rollers 40 function to guide the relative rotation of the weights 30 within a range defined by the pendulum holes H. The weights 30 apply a force like a force that momentarily pulls the pendulum rollers 40 in the direction in which the weights 30 rotate, to the pendulum rollers 40. As a result, momentary rotational force can be applied to the rotors 20 in the direction opposite to the direction in which the rotors 20 rotate.

Therefore, a specific wave transmitted from the engine to the rotors 20 is offset by a wave resulting from relative rotational movement of the weights 30. Thereby, torsional rotational vibration can be markedly reduced. Meanwhile, because torsional vibration applied to the rotors 20 is transmitted to the transmission by the secondary flywheel 14, the magnitude of vibration transmitted to the interior of the transmission can be reduced. As a result, the present invention can enhance the NVH performance of the drive system, thus markedly enhancing the running performance of the vehicle, and making the running smooth.

As such, in the present invention, the weights 30 rotate relative to the rotors 20 in the direction opposite to the direction in which the rotors 20 are rotated by torsional vibration that is momentarily generated, thus absorbing and reducing the torsional vibration of the engine before it is transmitted to the transmission.

Particularly, in the present invention, the weights 30 are interposed between the two rotors 20 rather than being disposed on opposite sides of the rotor 20. Therefore, the center of gravity and the inertia of the weights 30 in the rotors 20 can be easily controlled so that the workability for installation of the weights 30 can be enhanced. Further, the rotational balance of the weight is reliably maintained. As a result, the vibration reduction performance of the damping apparatus can be markedly enhanced.

Furthermore, the rotors 20 are configured such that a circumferential portion between the rotors 20 is open. This makes it possible to install the weights 30 between the rotors 20 in such a way that the weights 30 slightly protrude outward from the circumferences of the rotors 20. Therefore, the weights 30 can be disposed as far away from the center of the rotors 20 as possible, so that the vibration reduction performance of the weights 30 can be markedly increased.

Moreover, the pins 26 which fasten the two rotors 20 to each other can be installed such that they do not interfere with the weights 30. Hence, it is not necessary to form separate holes for installation of the pins 26 in the rotors 20. The durability of the rotors 20 can thus be enhanced. In addition, a problem of the weight of the rotors 20 being reduced if holes are formed in the rotors 20 can be solved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A damping apparatus of a flywheel, comprising:
a pair of rotors provided with the flywheel and rotating along with the flywheel, the rotors receiving torsional vibration from an engine through the flywheel, wherein the rotors face each other at a predetermined interval and are restricted from rotating relative to each other; and
a weight provided between the rotors, the weight rotating relative to the rotors in a direction in which the torsional vibration transmitted to the rotors is offset;
wherein the flywheel comprises a primary flywheel and a secondary flywheel that are connected to opposite ends of the rotors;
wherein a first end of the rotors is fastened to either the primary flywheel or the secondary flywheel;
wherein a second end of the rotors is rotatably coupled to a remaining one of the primary flywheel and the secondary flywheel by a damping spring;
wherein a fastening member is provided on the rotors in such a shape that the fastening member covers portions of two other edges of the rotors;
wherein the fastening member is fastened to the rotors by a pin:
wherein a connection piece extends outward from an upper center portion of the fastening member; and
wherein a first end of the damping spring is connected to the connection piece.

2. The damping apparatus as set forth in claim 1, wherein a pendulum hole is formed in each of the weight and the rotors, wherein the pendulum holes extend in a direction in which the weight and the rotors rotate relative to each other, and
a pendulum roller is disposed in the pendulum holes and movable in the pendulum holes so that the weight is able to rotate relative to the rotors.

3-5. (canceled)
